(19) United States
(12) Patent Application Publication
(10) Pub. No.: US 2009/0250495 A1
(43) Pub. Date: Oct. 8, 2009

(54) Portable Cargo Trailer Tool Pouch

(75) Inventor: Troy S. Sonnier, Baton Rouge, LA (US)

Correspondence Address: Troy S. Sonnier, 669 Rapides St, Baton Rouge, LA, 70806, US

(73) Assignee: Troy Sonnier, Baton Rouge, LA (US)

(21) Appl. No.: 12/411,438

(22) Filed: Mar. 26, 2009

Related U.S. Application Data
(60) Provisional application No. 61/043,154, filed on Apr. 8, 2008.

(51) Int. Cl. B60R 7/00

(52) U.S. Cl. 224/401; 224/543

(57) ABSTRACT

A portable cargo trailer tool pouch is a storage device for securing tools and other objects in an enclosed trailer in an organized fashion without using valuable floor space. The tool pouch is formed from a back panel (20) made of durable fabric that has a plurality of pockets (30) of varying sizes secured to the back panel (20). The tool pouch has a plurality of metal grommets (120) along the top edge (112) of the panel (20) that permit the fully loaded tool pouch to be mounted in the enclosed trailer by hanging the grommets (120) on preinstalled hooks or nails on the interior wall or door(s) of the trailer. This embodiment, fully loaded with tools and other objects, may be easily carried by two handle straps (110) secured at the top edge (112) of the panel (20).

### CROSS-REFERENCE TO RELATED APPLICATIONS

This application claims the benefit of provisional patent application Ser. No. 61/043,154, filed Apr. 8, 2008 by present inventor.

### FEDERALLY SPONSORED RESEARCH

Not Applicable

### SEQUENCE LISTING OR PROGRAM

Not Applicable

### BACKGROUND

1. Field

This application relates to tool storage devices mounted in cargo trailers and methods of securing and storing tools and other objects in those trailers.

2. Prior Art

Cargo trailers are enclosed trailers that are used to transport tools, supplies and other objects of various sizes from one location to another. Cargo trailers include, but are not limited to utility trailers, horse trailers, auto trailers, motorcycle trailers, landscape trailers, and concession trailers. Conventional storage devices that are used in cargo trailers use large portions of floor space, which can be better utilized for other purposes. Conventional storage devices do not adequately secure objects during transportation of the trailer. They also do not allow a variety of tools, supplies and other objects to be stored in an organized manner.

Cargo trailer owners often install shelves in cargo trailers in order to store tools and other objects. Installation of shelves can be time consuming and expensive. Also, movement of the trailer can cause the tools and other objects to shift, slide, tip over or fall off the shelves causing damage to the object itself and to other objects in the trailer. Shelves also consume a large portion of the open space in the cargo trailer.

Storage boxes have also been used in cargo trailers to store and secure tools and other objects. However, storage boxes force the cargo trailer owner to forfeit valuable floor space of the cargo trailer that can be used to transport larger objects. Furthermore, storage boxes do not provide organized storage for smaller objects such as screwdrivers, flashlights, tape measures, pencils, etc.

Neither shelves nor storage boxes provide an easy method to transport all of the stored objects out of the trailer at once to the location of work or to a different storage location such as a garage or shed. Therefore, cargo trailer owners waste a lot of time traveling between the trailer and the work site to retrieve tools.

A tool pouch is a flexible, object storage receptacle. There are many conventional tool pouches designed to keep small, handheld tools organized; however, they are not capable of storing larger tools like drills, pneumatic nailers, electric sanders, reciprocating saws, etc. Many of these tool pouches are flexible tool pouches with many slender pockets designed to carry and store hand tools, such as wrenches. They are designed for an individual to roll up and carry. These devices are not useful for an individual who also desires to organize larger tools, supplies, and other objects. Also, these conventional tool pouches do not provide an easy way to identify the contents of the pockets without having to search through the pockets. Furthermore, conventional tool pouches are not designed with the cargo trailer in mind.

Therefore, there is need for an easily installed storage device designed specifically for use in cargo trailers that provides organized storage and secures objects from moving during transport of the trailer. There is also need for a storage device that has a narrow profile and does not require using valuable floor space of the cargo trailer that can be used for larger objects. There is need for a storage device that can take advantage of not only trailer wall space, but also trailer door space. It is also desirable that the storage device is portable so that all of the stored tools and objects can be transported into and out of the trailer at will. There is need for a storage device that can be installed not only in a cargo trailer, but also in a garage, shed or any other location that easy accessibility to the stored objects would be needed. It is desirable that the storage device has a means for the user to easily identify the contents of the storage device without wasting time to search for the desired stored object.

### SUMMARY

In accordance with one embodiment, a portable cargo trailer tool pouch comprises a back panel of durable fabric that has a plurality of pockets also made of durable fabric to store a multitude of tools and other objects of different sizes. The embodiment of the tool pouch has a plurality of metal grommets installed along the top edge of the back panel. The embodiment of the tool pouch has one or more handle straps secured at the top of the back panel. The pockets on the embodiment of the tool pouch optionally include flaps secured by fasteners. The pockets are optionally decoratively trimmed. Each pocket on the embodiment optionally has a label holder.

### DRAWINGS—FIGURES

FIG. 1 is a front perspective of the tool pouch with two handle straps.

FIG. 2 is a back perspective of the tool pouch in FIG. 1.

FIG. 3 is a detailed view of one of the large capacity pockets.

FIG. 4 is a front perspective of the tool pouch with one handle strap.

FIG. 5 is a front perspective of the tool pouch with two cutout handles.

FIG. 6 is a front perspective of the tool pouch with one cutout handle.

FIG. 7 is a front perspective of the tool pouch with two foam padded handle additions.

FIG. 8 is a detailed view of the foam padded handle addition shown in FIG. 7.

FIG. 9 is a front perspective of the tool pouch with two rubber padded handle additions.

FIG. 10 is a detailed view of the rubber padded handle addition shown in FIG. 9.

### DRAWINGS—REFERENCE NUMERALS

| | | | |
|---|---|---|---|
| 20 | back panel | 30 | pocket |
| 40 | open end of pocket | 42 | closed end of pocket |
| 44 | side of pocket | 46 | overlay panel |
| 48 | decorative trim | 50 | label holder |
| 52 | closed end of label holder | 54 | open end of label holder |
| 56 | side of label holder | 58 | label |
| 60 | large capacity pocket | 62 | box pleat |
| 80 | pocket flap | 82 | flap stitching |
| 90 | undersurface of pocket | 100 | flap fastener |
| | flap | | |
| 105 | mate of flap fastener | 110 | handle strap |
| 112 | top edge of back panel | 120 | metal grommet |
| 150 | cutout handle | 160 | reinforcement trim |
| 170 | foam padded handle grip | 180 | tubular rigid core |
| 190 | padding | 200 | opening of foam handle |
| 210 | rubber padded handle | 220 | internal rubber tube |
| 230 | rubber grip | | |

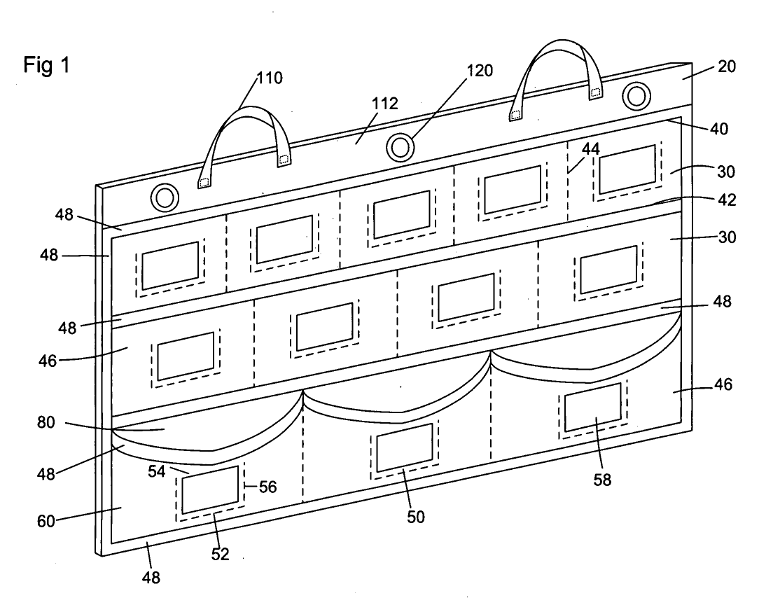

### DETAILED DESCRIPTION—FIGS. 1, 2, AND 3—FIRST EMBODIMENT

One embodiment of the tool pouch is illustrated in FIG. 1. The tool pouch has a back panel 20 which may be constructed from canvas, nylon or any other durable fabric. A plurality of pockets 30 are stitched to the front of the back panel 20. The pockets 30 in this embodiment are made of the same material as the back panel 20. The pockets are adapted to hold numerous tools and objects of different sizes. Each pocket 30 is defined by an open end 40, a closed end 42, and sides 44 or stitching walls. The pockets 30 are formed by stitching the bottom edge of an overlay panel 46 to the back panel 20, and inserting stitching walls 44 that extend from the open end 40 to the closed end 42. The overlay panel 46 is the same width as the back panel 20 and the same height as that row of pockets 30. Each pocket 30 in this embodiment has decorative trim 48 stitched at the open end 40 as well as along the closed end 42. The decorative trim 48 in this embodiment is made of nylon webbing or some other durable material. In this embodiment decorative trim 48 is also stitched along the sides of the back panel 20. The decorative trim 48 can be stitched to any edge and should not be limited to the locations in this embodiment.

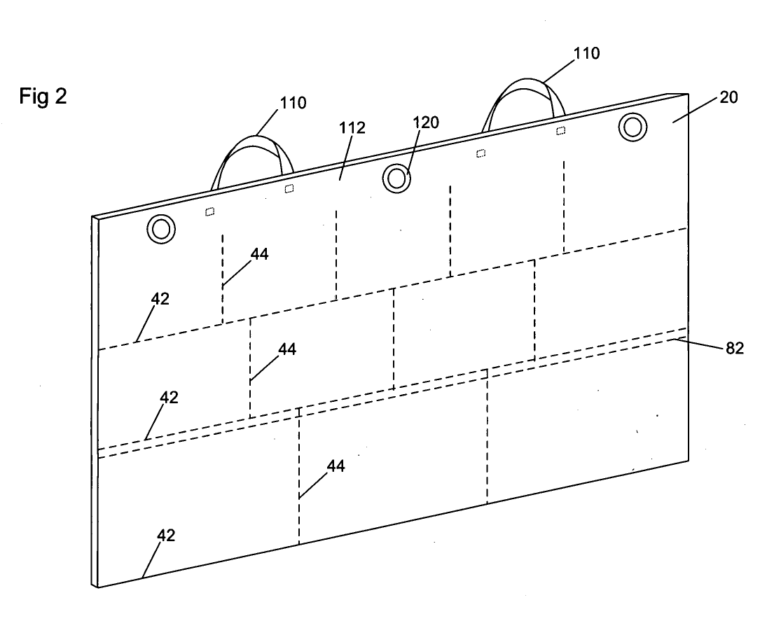

The back perspective of this embodiment is shown FIG. 2. In this illustration, the stitching walls for the sides of the pockets 44 and the stitching for the closed end of the pockets 42 are apparent.

On the embodiment in FIG. 1, label holders 50 made of transparent vinyl or a similar material can be stitched or glued to the front of some pockets 30 so that the user can identify the contents of each pocket 30 when the pockets 30 are made of non-transparent material such as canvas or nylon. Each label holder 50 is defined by a closed end 52, an open end 54, and sides 56. The user can write the contents of the pocket 30 on a piece of paper or label 58 and insert it into the label holder 50. In other embodiments there may be no label holders at all.

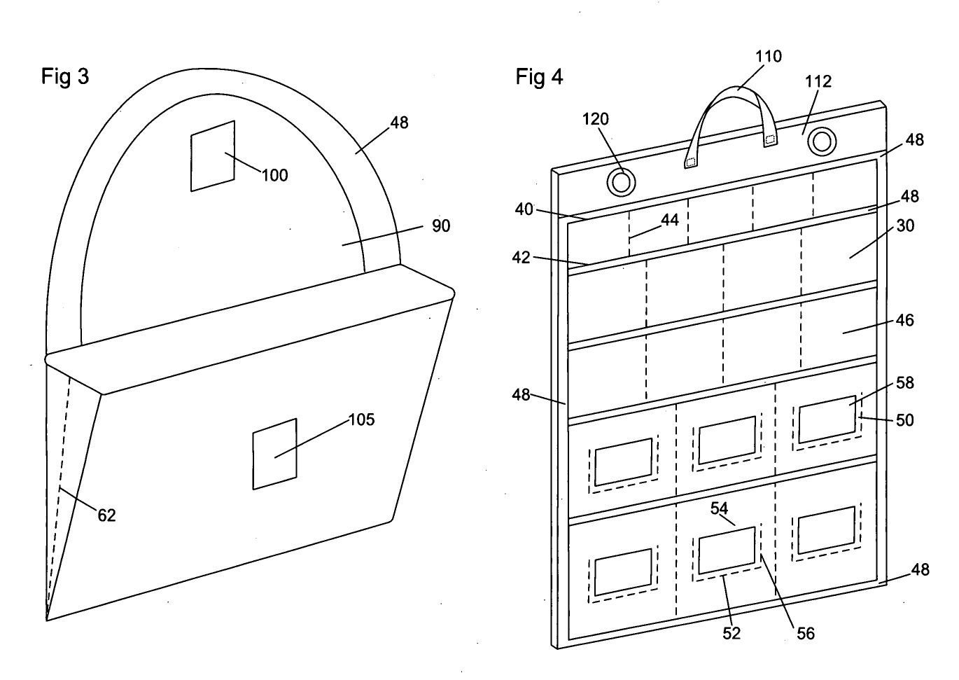

On the embodiment in FIG. 1, large capacity pockets 60 are used on the bottom row of the tool pouch. As detailed in FIG. 3, the large capacity pockets 60 are created by stitching the overlay panel 46 to the back panel 20 with a box pleat 62 along the side of the large capacity pocket 60. The width of the overlay panel 46 used to form the large capacity pockets 60 will be greater than the width of the back panel 20 to accommodate for the box pleats 62. Although a box pleat 62 is used in this embodiment, a knife pleat, double box pleat, and any other appropriate pleat may be used to increase the capacity of the pockets 60. In other embodiments there may be no large capacity pockets 60 at all. Furthermore, additional rows of large capacity pockets 60 in other embodiments may be used.

Referring back to FIG. 1, each pocket 60 on the bottom row of pockets 60 is constructed with a flap 80 in order to maintain a narrow profile for the high capacity pocket 60. The flap 80 also helps to secure the objects stored inside during transportation. Although flaps 80 are used in this embodiment on the large capacity pockets 60 only, they may be used on any pocket 30. The flap 80 is stitched to the back panel 20 and covers the top edge of the pockets 60. The flap 80 has decorative trim 48 along its edge. In FIG. 2 the flap stitching 82 that secures the flap to the back panel 20 is evident. As detailed in FIG. 3, on the undersurface 90 of the flap 80 is a snap, hook-and-loop fastener, or some other type of fastener 100 that engages with its mate 105 on the front of the pocket 60. Other embodiments may have no flaps 80 at all.

Referring to FIG. 1, two handle straps 110 are stitched along the top edge 112 of the back panel 20 so that the tool pouch may be transported. The handle straps 110 can be made of a variety of durable materials including nylon webbing. The handle straps 110 make it possible for the tool pouch to be carried while it is fully loaded with tools and other objects.

Referring to FIG. 1, a plurality of metal grommets 120 are set in across the top edge 112 of the tool pouch. The tool pouch is mounted in the cargo trailer by hanging the grommets 120 on preinstalled hooks or nails on the interior wall or door of the trailer. Because this tool pouch is portable, it can also be hung in a storage room or any other location where there are preinstalled hooks or nails on a wall.

### FIG. 1—Second Embodiment—Transparent Vinyl Pockets

Transparent vinyl or other similar, durable material can be used as an alternative to the non-transparent fabric that is used for the regular pockets 30 or the large capacity pockets 60 in the first embodiment. Transparent vinyl will allow the user to easily identify the contents of each pocket without the need for a label holder 50.

### FIG. 4—Third Embodiment—One Handle Strap

The third embodiment is shown in FIG. 4. The tool pouch has only one handle strap 110 that is centrally located along the top edge 112 of the tool pouch.

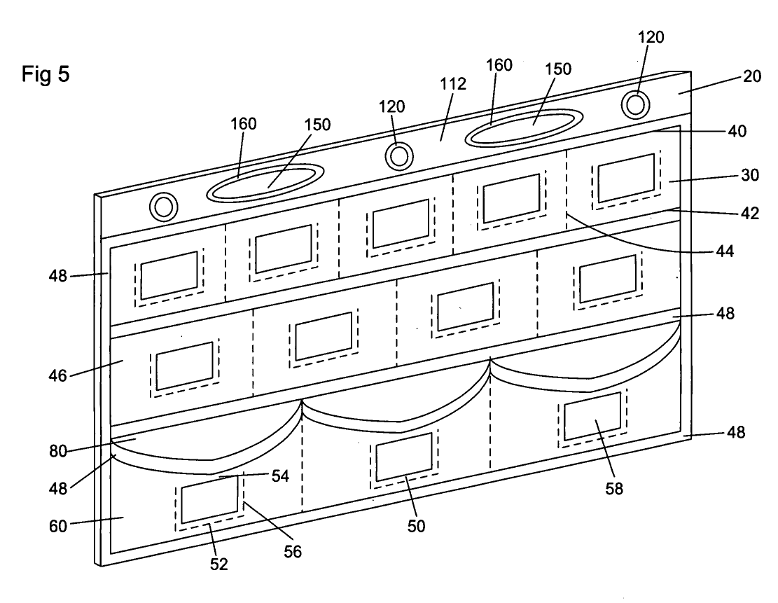

### FIG. 5—Fourth Embodiment—Two Cutout Handles

The fourth embodiment is shown in FIG. 5. The two handle straps 110 in the first embodiment have been eliminated from the tool pouch. Two cutout handles 150 have been installed along the top edge 112 of the back panel 20. The cutout handles 150 may be optionally reinforced with trim 160 made of nylon webbing or some other durable material that is stitched around the cutout 150.

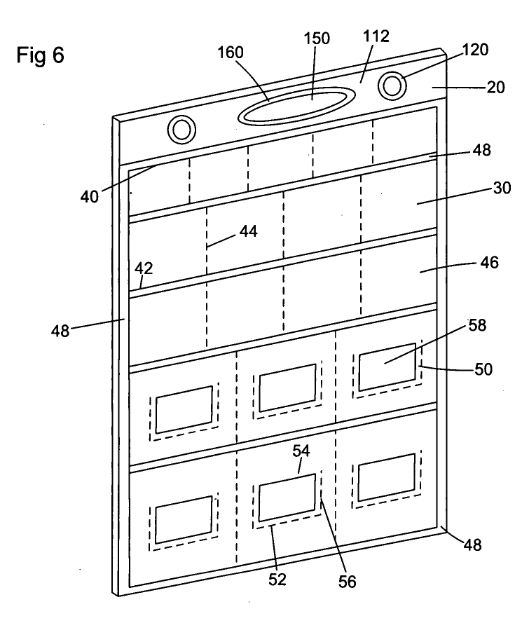

### FIG. 6—Fifth Embodiment—One Cutout Handle

The fifth embodiment is shown in FIG. 6. The two handle straps 110 in the first embodiment have been eliminated from the tool pouch. One cutout handle 150 has been installed along the center of the top edge 112 of the back panel 20. The cutout handle 150 may be optionally reinforced with trim 160 made of nylon webbing or some other durable material that is stitched around the cutout 150.

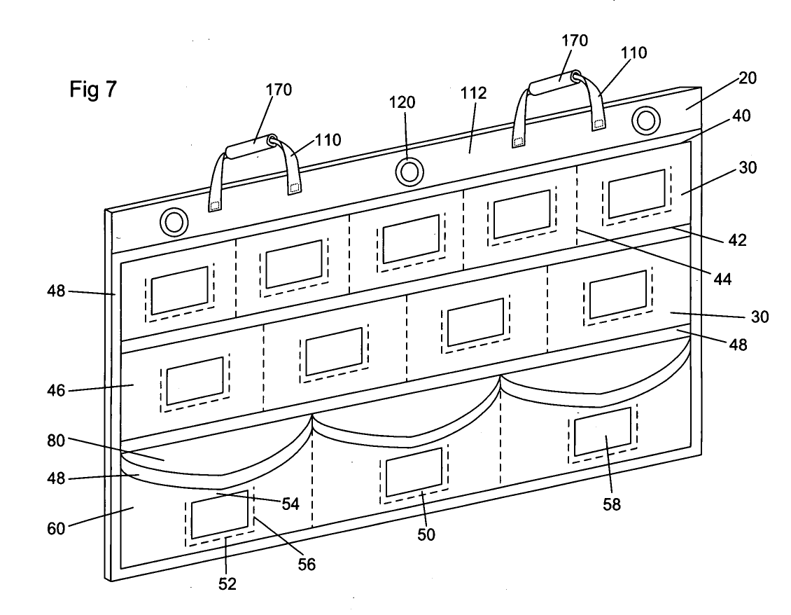

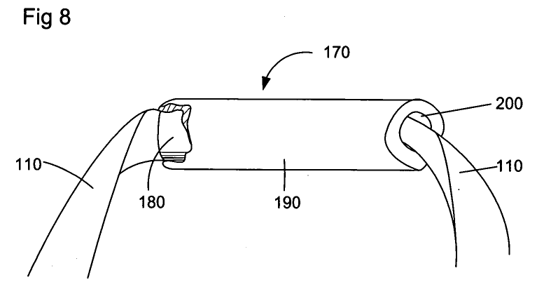

### FIGS. 7 and 8—Sixth Embodiment—Foam Padded Handle Addition

The sixth embodiment as shown in FIG. 7 includes a foam padded handle 170 that can be added to each handle strap 110 for comfort. As shown in detail in FIG. 8, the foam padded handle 170 is composed of a tubular rigid core 180 that is made of a plastic material such as polyvinyl chloride. Padding 190, that is a layer of resilient material such as polyurethane foam, is bonded to the outer surface of the core 180. The handle strap 110 is flexible and extends freely through the central opening 200 of the core 180.

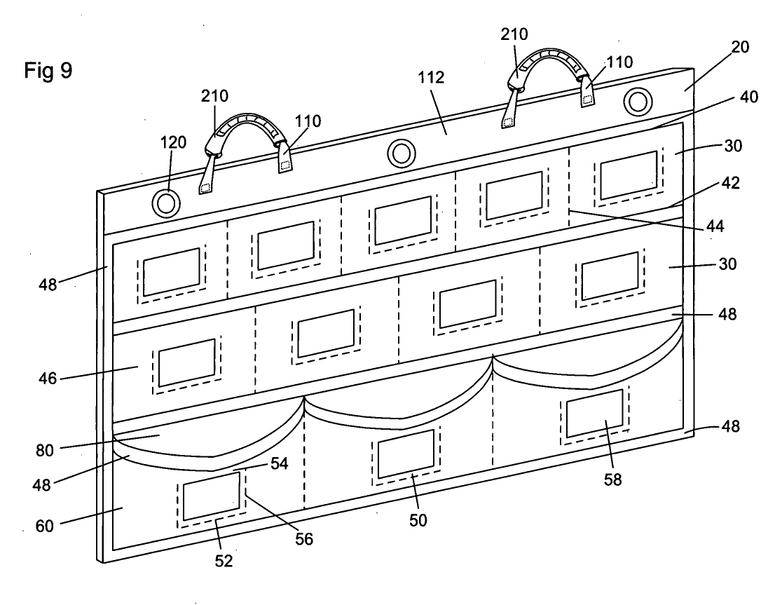

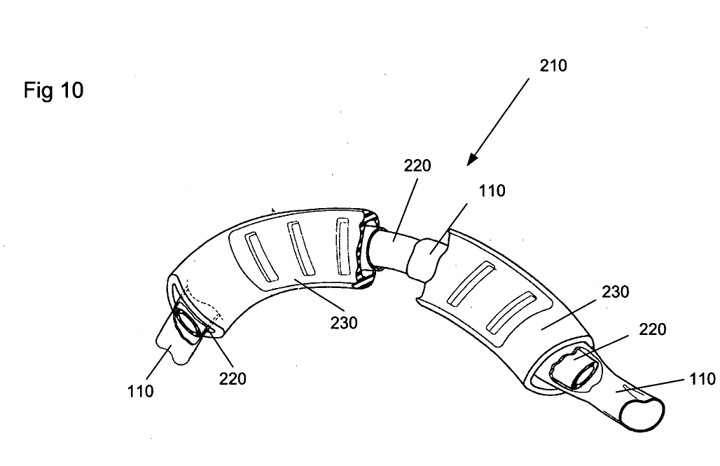

### FIGS. 9 and 10—Seventh Embodiment—Rubber Padded Handle Addition

The seventh embodiment as shown in FIG. 9 includes a rubber padded handle 210 that can be added to each handle strap 110 for comfort. As shown in detail in FIG. 10, the handle strap 110 has its central portion rolled up to enclose a flexible rubber tube 220. Surrounding the exterior of the central portion of the handle strap 110 is a flexible, tubular rubber grip 230 that is concentric with the internal tube 220. The grip 230 is elongated, flexible, and optionally curved to conform to the curvature of the hand. Because the interior of the grip 230 contains the rubber tube 220, the rubber padded handle 210 stays in one position and does not freely move about the handle strap 110.

### Advantages

From the description above, a number of advantages of some embodiments of my cargo trailer tool pouch become evident:
(a) The cargo trailer tool pouch creates a storage system for enclosed trailers that has not been previously addressed. It replaces bulky, expensive, permanent, custom shelving that has been used to store and organize tools and other items in cargo trailers.
(b) The cargo trailer tool pouch is designed to store and organize not only small tools and other objects, but also large tools such as drills, pneumatic nailers, electric sanders, reciprocating saws, etc.
(c) The narrow profile of the tool pouch allows the cargo trailer owner to take full advantage of the floor space of the trailer for larger objects. Shelving and other traditional storage systems use a large amount of this valuable floor space.
(d) The tool pouch can be installed on both the walls and the door(s) of the trailer.

Shelving and storage boxes do not allow the trailer owner to take advantage of the space on the door(s) of the trailer.
(e) Because the tool pouch is portable, it is possible to transport all stored tools and items needed for the task at hand from the trailer to the area of work at once. Also, it is possible to transport all stored tools out of the trailer for safe storage when the trailer is vulnerable to burglary.
(f) The cargo trailer tool pouch is easy to install. It simply requires hanging on pre-installed hooks with spacing equivalent to the grommet spacing.
(g) The label holders on the tool pouch allow the user to quickly identify the contents of the pockets without wasting time to search the pockets.
(h) The flaps on the pockets maintain a narrow profile for the tool pouch and allow for secure storage of the objects during transportation.
(i) The cargo trailer tool pouch can also be used to store tools and other objects in garages, sheds or anywhere with pre-installed hooks.

### Conclusions, Ramifications, and Scope

Accordingly, the reader will see that the portable cargo trailer tool pouch of the various embodiments can be used to store tools and other objects within an enclosed trailer easily and without timely and costly installation of bulky shelves or boxes. In addition, the portability of the tool pouch allows the user to transfer all of the tools needed to the location of work without having to make many trips to the trailer to retrieve a tool. Furthermore, the portable cargo trailer tool pouch has the additional advantages in that:
its slim contour allows full use of the floor of the trailer;
it allows the cargo trailer owner to take advantage of the space on the door(s) of the trailer;
it is easy and quick to install;
its portability allows the user to transfer the stored tools and objects to a more secure location when the trailer is at risk of a break-in;
its label holders provide easy identification and location of stored objects; and
it provides a versatile storage system that can not only be used in cargo trailers, but also garages, sheds and other places where easy access to tools and other objects of varying sizes might be needed.

Although the description above contains many specificities these should not be construed as limiting the scope of the embodiments, but as merely providing illustrations of some of the presently preferred embodiments.

Thus the scope of the embodiments should be determined by the appended claims and their legal equivalents, rather than by the examples given.

I claim:

1. A flexible object storage receptacle for hanging on a vertical surface of an enclosed trailer comprising:
a. a back panel made of a durable fabric, said back panel having a front and a top edge
b. a plurality of pockets of varying sizes attached to said front of said back panel, said pockets each having a front and a top edge
c. means for hanging said storage receptacle on said vertical surface, and
d. means for carrying said storage receptacle,
whereby objects can be neatly and securely stored during movement of said enclosed trailer, and said objects can be carried at once in said storage receptacle to a different location.

2. The object storage receptacle of claim 1 wherein said pockets are made of said durable fabric.

3. The object storage receptacle of claim 1 wherein said pockets are made of a durable, transparent vinyl or similar material.

4. The object storage receptacle of claim 1 wherein said means for hanging comprises a plurality of grommets installed along said top edge of said back panel.

5. The object storage receptacle of claim 1 wherein said means for carrying said storage receptacle comprises one or more handle straps secured to said top edge of said back panel.

6. The object storage receptacle of claim 5 further including a handle attached on each said handle strap.

7. The object storage receptacle of claim 1 wherein said means for carrying said storage receptacle comprises one or more cutout handles installed along said top edge of said back panel.

8. The object storage receptacle of claim 1 further including a label holder secured to said front of each said pocket.

9. The object storage receptacle of claim 1 further including a flap secured to said front of said back panel above said top edge of each said pocket covering said top edge of said pocket, said flap having an undersurface.

10. The object storage receptacle of claim 9 further including a fastener secured to said undersurface of said flap that engages with a mate attached to said front of said pocket.

11. A method of storing objects on a vertical surface within an enclosed trailer, comprising:
a. providing an object storage receptacle of the type comprising a back panel with a top edge made of a durable fabric, a plurality of pockets of varying sizes attached to said back panel, a plurality of grommets installed along said top edge of said back panel, and a means for carrying said storage receptacle,
b. providing a plurality of hanging fasteners equal in number to said grommets preinstalled on said vertical surface,
c. hanging said grommets of said storage receptacle on said hanging fasteners,
whereby said objects can be neatly and securely stored during movement of said enclosed trailer.

12. The method of claim 11 wherein said means for carrying said storage receptacle comprises one or more handle straps secured to said top edge of said back panel.

13. The method of claim 11 wherein said means for carrying said storage receptacle comprises one or more cutout handles installed along said top edge of said back panel.
